(19) United States
(12) Patent Application Publication
(10) Pub. No.: US 2006/0087960 A1
(43) Pub. Date: Apr. 27, 2006

(54) Transmitter and receiver in an orthogonal frequency division multiplexing system using an antenna array and methods thereof

(75) Inventors: Eung-Sun Kim, Suwon-si (KR); Jong-Hyeuk Lee, Seongnam-si (KR); Gi-Hong Im, Pohang-si (KR); Jong-Bu Lim, Pohang-si (KR)

Correspondence Address: DILWORTH & BARRESE, LLP, 333 EARLE OVINGTON BLVD., UNIONDALE, NY, 11553, US

(73) Assignees: SAMSUNG ELECTRONICS CO., LTD., Suwon-si (KR); POSTECH FOUNDATION, Pohang-si (KR)

(21) Appl. No.: 11/116,909

(22) Filed: Apr. 28, 2005

(30) Foreign Application Priority Data
Oct. 25, 2004 (KR) 85303/2004

(51) Int. Cl. H04J 11/00

(52) U.S. Cl. 370/203

(57) ABSTRACT

A new diversity scheme for orthogonal frequency division multiplexing/multi-input multi-output (OFDM/MIMO) systems. The new diversity scheme, i.e., turbo layered space-frequency coded OFDM (TLSFC-OFDM), uses the turbo principle with space hopping (SH). The TLSFC-OFDM system uses a successive interference cancellation (SIC) algorithm to reduce the number of iterations. As a result, this scheme reduces computational complexity. Simulation results show that the SIC-based TLSFC-OFDM system outperforms a conventional OFDM/Horizontal Bell Labs Layered Space-Time (H-BLAST) system using a horizontal coding scheme.

### PRIORITY

This application claims priority to an application entitled “TRANSMITTER ND RECEIVER IN AN ORTHOGONAL FREQUENCY DIVISION MULTIPLEXING SYSTEM USING AN ANTENNA ARRAY AND METHODS THEREOF”, filed in the Korean Intellectual Property Office on Oct. 25, 2004 and assigned Serial No. 2004-85303, the contents of which are incorporated herein by reference.

### BACKGROUND OF THE INVENTION

1. Field of the Invention

The present invention relates to a data transmitter and receiver in a mobile communication system supporting an orthogonal frequency division multiplexing (OFDM) scheme, and methods thereof.

2. Description of the Related Art

Mobile communication systems are developing into high-speed and high-quality wireless data packet communication systems, which provide data services and multimedia services in addition to conventional voice services. The standardization for high-speed downlink packet access (HSDPA) of the Third Generation Partnership Project (3GPP) and 1× evolution data and voice (1×EV-DV) of the Third Generation Partnership Project 2 (3GPP2) can be the solution for high-speed and high-quality services.

Channel environment is one factor capable of degrading high-speed and high-quality service in the mobile communication system. For example, a wireless channel environment exhibits low reliability on multipath interference, shadowing, radio wave attenuation, time-variant noise, etc. This serves as a factor capable of degrading a data transmission rate. To overcome the degradation, many schemes have been developed. For example, an error control coding scheme for counterbalancing signal distortion effects and a diversity scheme for overcoming fading have been developed.

Available methods for obtaining diversity in the mobile communication system include temporal, frequency, multipath, and spatial diversities. Temporal diversity is obtained by combining channel coding and interleaving, frequency diversity is obtained by using different multipath signals transmitted at different frequencies, multipath diversity is obtained by separating multipath signals using different fading information, and spatial diversity is obtained by different independent fading signals using multiple antennas in at least one of a transmitter and a receiver. Additionally, spatial diversity uses an antenna array.

A mobile communication system using the antenna array, i.e., a multi-antenna system, is equipped with multiple antennas in a transmitter/receiver, and uses a space domain for improving frequency efficiency. It is easy for a high transmission rate to be obtained through the use of the space domain as compared with the use of limited time and frequency domains. Multi-antenna systems are capable of providing much higher capacity than conventional wireless systems. Accordingly, the multi-antenna systems can significantly improve the performance of wireless communication systems.

A multi-antenna system sends independent information from antennas and inherently serves as a multi-input multi-output (MIMO) system. The MIMO antenna system is used to improve reliability and transmission efficiency through spatial multiplexing, space-time coding, etc., without increasing a frequency band or transmission power. For example, the Diagonal Bell Labs Layered Space-Time (D-BLAST) system is a commonly used MIMO antenna system. However, the D-BLAST system is inappropriate for short packet transmissions due to boundary wastage at the beginning and end of each packet.

Accordingly, the Vertical BLAST (V-BLAST) system was proposed to overcome the drawback of the D-BLAST system. However, the V-BLAST system suffers from the inability to work with fewer receive antennas than transmit antennas. This drawback is important for modern cellular systems because a base station typically has more antennas than a mobile terminal. Further, because the V-BLAST system transmits independent data streams on its antennas, there is no built-in spatial coding to guard against deep fades from any given transmit antenna. That is, the V-BLAST system provides a multiplexing gain, but does not provide a transmit diversity gain.

### SUMMARY OF THE INVENTION

It is, therefore, an aspect of the present invention to provide a turbo layered space-frequency coded orthogonal frequency division multiplexing (TLSFC-OFDM) system.

It is another aspect of the present invention to provide a new diversity scheme for an orthogonal frequency division multiplexing/multi-input multi-output (OFDM/MIMO) system.

It is another aspect of the present invention to provide a transmitter and method for rearranging symbols to be transmitted using a space hopping scheme and transmitting the rearranged symbols.

It is another aspect of the present invention to provide a receiver and method for demodulating modulated symbols using the turbo principle.

It is another aspect of the present invention to provide a transceiver and method providing both a multiplexing gain and a transmit diversity gain in an orthogonal frequency division multiplexing (OFDM) system.

It is another aspect of the present invention to provide an apparatus and method for demodulating modulated symbols using an iterative equalization algorithm in an orthogonal frequency division multiplexing (OFDM) system.

It is another aspect of the present invention to provide a turbo layered space-frequency coded orthogonal frequency division multiplexing (TLSFC-OFDM) system to which a successive interference cancellation (SIC) scheme is applied in order to reduce the number of iterations required for convergence when data is demodulated.

It is yet another aspect of the present invention to provide a method for reducing computation complexity, thereby reducing the number of iterations required for convergence when data is demodulated.

The above and other aspects of the present invention can be achieved by a method for transmitting symbol streams in a transmitter of a mobile communication system supporting an orthogonal frequency division multiplexing (OFDM) scheme. The transmitter includes a plurality of transmit antennas. The transmitter separates one data stream into a plurality of substreams, encodes the plurality of substreams, and outputs the symbol streams. The method includes performing space hopping between the symbol streams; rearranging symbols configuring the symbol streams; transforming the rearranged symbol streams using Inverse Fast Fourier Transform (IFFT); inserting cyclic prefixes (CPs) into the transformed rearranged symbol streams; and transmitting, through corresponding transmit antennas, the transformed rearranged symbol streams into which the CPs have been inserted.

Additionally, the present invention can be achieved by a transmitter of a mobile communication system supporting an orthogonal frequency division multiplexing (OFDM) scheme. The transmitter separates one data stream into a plurality of substreams, encodes the plurality of substreams, and outputs the symbol streams. The transmitter includes a space hopper for performing space hopping between the symbol streams, and rearranging symbols configuring the symbol streams; Inverse Fast Fourier Transform (IFFT) processors for transforming the rearranged symbol streams using IFFT; cyclic prefix (CP) inserters for inserting CPs into the symbol streams modulated by the IFFT; and transmit antennas for transmitting the modulated symbol streams into which the CPs have been inserted.

### BRIEF DESCRIPTION OF THE DRAWINGS

The above and other aspects and advantages of the present invention will be more clearly understood from the following detailed description taken in conjunction with the accompanying drawings, in which:

FIG. 1 is a block diagram illustrating a transmitter in accordance with an embodiment of the present invention;

FIG. 2 is a block diagram illustrating a receiver in accordance with an embodiment of the present invention;

FIG. 3A illustrates a matrix of symbols streams before rearrangement in accordance with an embodiment of the present invention;

FIG. 3B illustrates a mapping matrix for rearranging symbols illustrated in FIG. 3A;

FIG. 3C illustrates a matrix of rearranged transmission symbol streams in accordance with an embodiment of the present invention;

FIG. 4 illustrates a structure for performing an iterative equalization algorithm in a turbo layered space-frequency coded orthogonal frequency division multiplexing (TLSFC-OFDM) system in accordance with an embodiment of the present invention;

FIG. 5A is a graph illustrating simulation results when a space hopping (SH) scheme proposed by the present invention is not applied;

FIG. 5B is a graph illustrating simulation results when the SH scheme proposed by the present invention is applied;

FIG. 6 is a flow chart illustrating a turbo equalization procedure in the TLSFC-OFDM system, without using a successive interference cancellation (SIC) algorithm proposed by the present invention;

FIG. 7 is a flow chart illustrating a turbo equalization procedure in the TLSFC-OFDM system using the SIC algorithm proposed by the present invention;

FIG. 8 is a graph illustrating a bit error rate (BER) performance comparison between the TLSFC-OFDM system with an exact minimum mean square error (MMSE) solution proposed by the present invention and a conventional OFDM/Horizontal Bell Labs Layered Space-Time (H-BLAST);

FIG. 9 is a graph illustrating a BER performance comparison between an OFDM/H-BLAST system using a conventional turbo principle and a TLSFC-OFDM system using the SIC algorithm proposed by the present invention; and

FIG. 10 is a graph illustrating BER performances according to the number of iterations in the TLSFC-OFDM system with a simplified MMSE solution proposed by the present invention and an SIC-based TLSFC-OFDM system.

### DETAILED DESCRIPTION OF THE PREFERRED EMBODIMENTS

Preferred embodiments of the present invention will be described in detail herein below with reference to the accompanying drawings. Additionally, these preferred embodiments of the present invention will be disclosed merely for illustrative purposes. Accordingly, those skilled in the art will appreciate that various modifications, additions, and substitutions are possible, without departing from the scope of the present invention.

In accordance with the present invention, a transmitter additionally includes a space hopping (SH) block, i.e., a space hopper, and a receiver uses a turbo principle as a soft-input soft-output demodulation scheme. This mobile communication system is referred to as the turbo layered space-frequency coded orthogonal frequency division multiplexing (TLSFC-OFDM) system. When the space hopper is added to the transmitter, both a multiplexing gain and a transmit diversity gain can be obtained. Because of the SH scheme, all layers have the same signal-to-noise ratio (SNR). Accordingly, a co-antenna interference (CAI) cancellation process can be performed in an arbitrary order.

Additionally, in accordance with the present invention, a successive interference cancellation (SIC) algorithm that performs interference cancellation without ordering and requires fewer iterations to converge is introduced into the TLSFC-OFDM system.

A. TLSFC-OFDM System

Hereinafter, a new diversity scheme (TLSFC-OFDM) proposed for an OFDM/multi-input multi-output (MIMO) system in accordance with the present invention will be described in detail. It is assumed in the detailed description of the present invention that a channel is unknown at the transmitter but is known at the receiver. Accordingly, transmission power is uniformly distributed to M_{T} antennas. For example, when total power is P, the transmission power distributed to an arbitrary transmit antenna is P/M_{T}. Further, it is assumed that the M_{T} transmit antennas operate with synchronized symbol timing at a rate of 1/T and that the sampling times of N_{R} receive antennas are symbol synchronous.

A-1. Structures of Transmitter and Receiver for TLSFC-OFDM

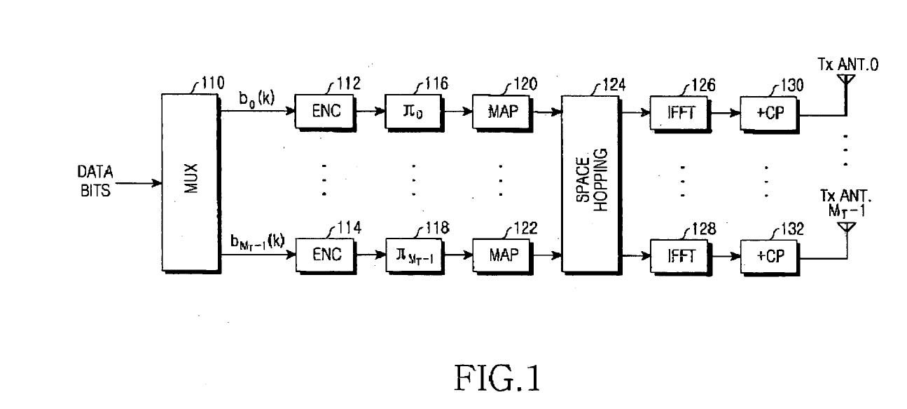

FIG. 1 is a block diagram illustrating a structure of the transmitter in accordance with an embodiment of the present invention. Referring to FIG. 1, a multiplexer 110 receives one data bit stream and outputs M_{T} subdata bit streams (b₀(k), . . . ,b_{M}_{_{T}}₋₁(k)). M_{T} can be determined by the number of transmit antennas.

The subdata bit streams (b₀(k), . . . ,b_{M}_{_{T}}₋₁(k)) are transferred to encoders 112 to 114, and are encoded. The encoded subdata bit streams are transferred to interleavers 116 to 118 and are independently interleaved. The interleaved encoded subdata bit streams are transferred to mappers 120 to 122. Each interleaved encoded subdata bit stream is mapped to an m-ary phase-shift keying (M-PSK) or m-ary quadrature amplitude modulation (M-QAM) symbol stream with the size of N, where N is the number of subcarriers.

The symbol streams are transferred to a space hopper 124, and are rearranged by SH. For example, symbols using the same frequency band in each symbol stream are rearranged by SH. The same frequency band can be distinguished subcarrier by subcarrier. A predetermined matrix X can define the symbol streams rearranged by SH. The matrix X is a transmission matrix of the TLSFC-OFDM system.

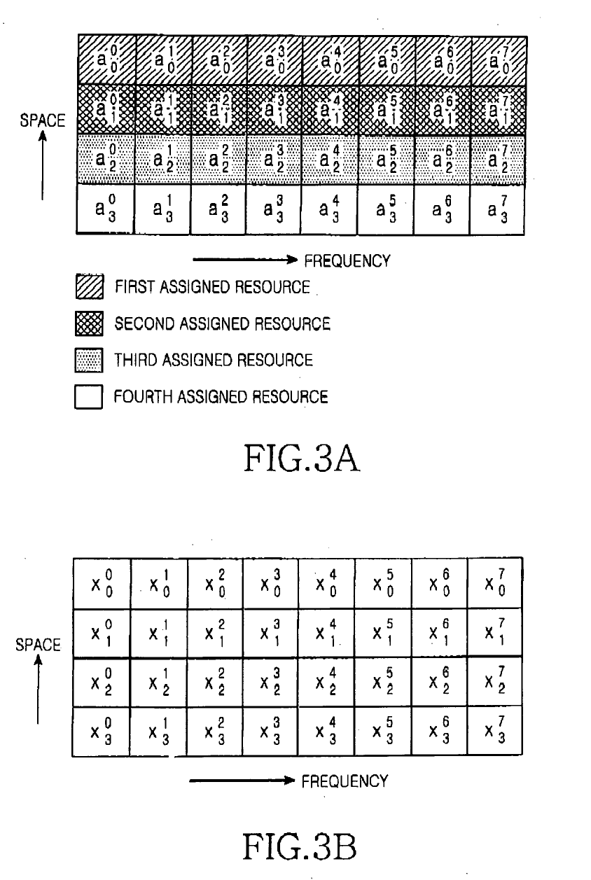

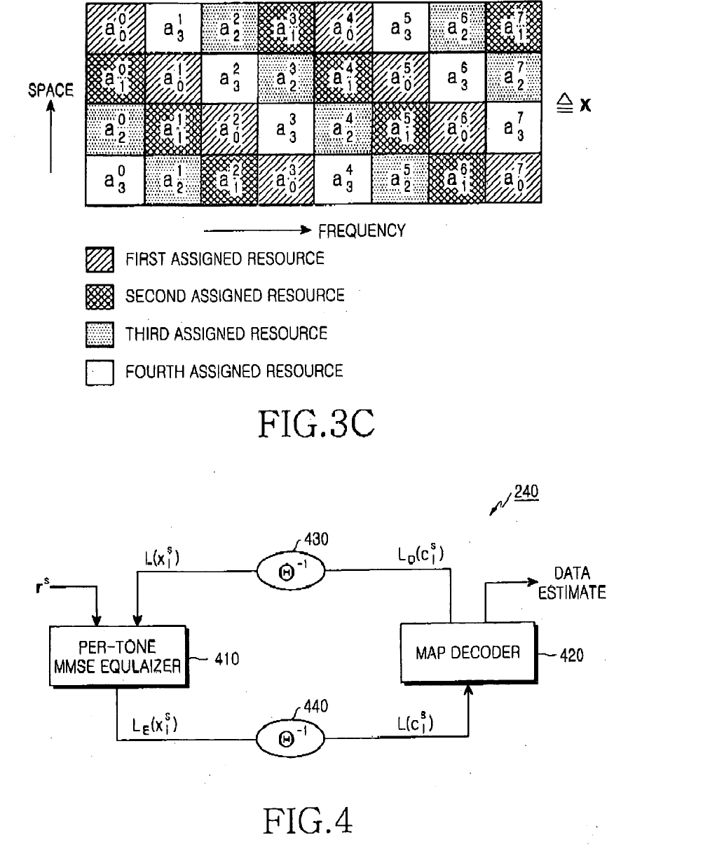

For example, where M_{T}=4 and N=8, the rearrangement of symbols streams will be described with reference to FIGS. 3A and 3B. More specifically, FIG. 3A illustrates a symbol stream matrix before the rearrangement.

In FIG. 3A, aᵢ^{s} is the s-th element (i.e., symbol) of the i-th symbol stream. As illustrated in FIG. 3A, symbols within each symbol stream have the same i value, and the s value is monotonously increased.

FIG. 3B illustrates a mapping matrix for rearranging the symbols illustrated in FIG. 3A. In FIG. 3B, xₖ^{s} denotes a position of the s-th row of the k-th column. In this case, the symbol arrangement of FIG. 3A is the same as that of FIG. 3B.

Accordingly, a mapping rule for mapping aᵢ^{s} to xₖ^{s} can be represented as shown in Equation (1).
xₖ^{s}=aᵢ^{s}, k=(i+s)mod M_{T} (1)

As seen from Equation (1), k must be determined such that aᵢ^{s} is mapped to xₖ^{s}. In Equation (1), k is determined by s, i, and M_{T}. For example, where s=3, i=3, and M_{T}=4, k is determined to be 2. Accordingly, a₃³ of FIG. 3A is rearranged in x₂³ of FIG. 3B.

As described above, when all symbols aᵢ^{s} illustrated in FIG. 3A are rearranged in positions xₖ^{s} of FIG. 3B, the transmission matrix X of FIG. 3C is obtained. It can be seen from FIG. 3C that SH has been achieved through the rearrangement of symbols of each symbol stream. That is, it can be seen that positions of symbols using the same subcarrier in each symbol stream have been changed. The SH scheme can reduce interference by uniformly distributing interference across a total frequency band. Accordingly, the proposed system can acquire both a transmit diversity gain and a multiplexing gain.

Referring again to FIG. 1, the rearranged symbol streams are transferred to Inverse Fast Fourier Transform (IFFT) processors 126 to 128, and are transformed into time domain symbol streams. The time domain symbol streams are transferred to cyclic prefix (CP) inserters 130 to 132, in which CPs are inserted into the time domain symbol streams. The time domain symbol streams into which the CPs have been inserted are transmitted through corresponding transmit antennas. For example, the first rearranged symbol stream of a₀⁰, a₃¹, a₂², a₁³, . . . illustrated in FIG. 3C is transmitted through the first transmit antenna Tx Ant. 0.

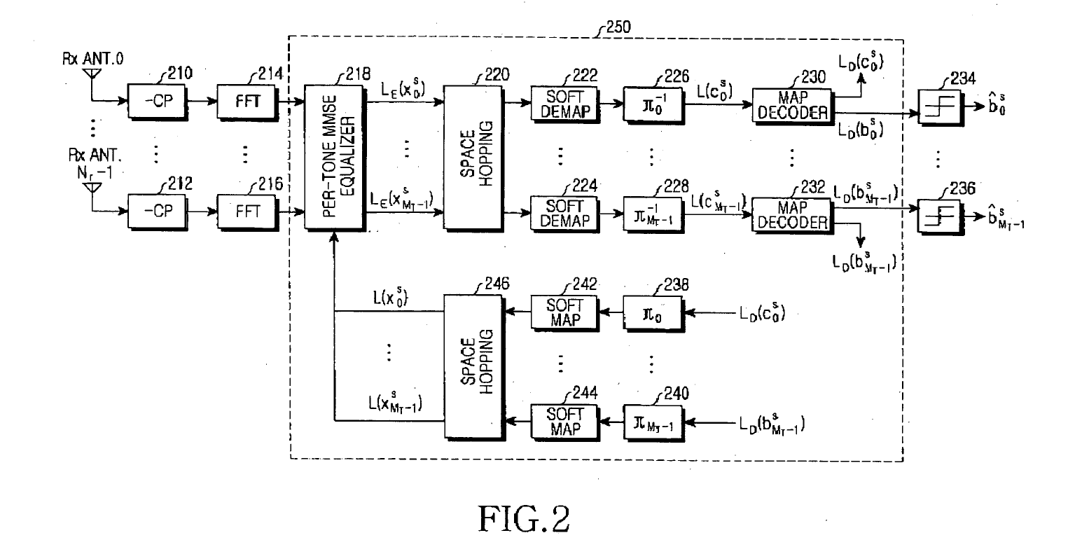

FIG. 2 is a block diagram illustrating a receiver in accordance with an embodiment of the present invention. Referring to FIG. 2, signals received by N_{R} receive antennas are transferred to CP removers 210 to 212, wherein CPs are removed from the received signals. The received signals from which the CPs have been removed are transferred to Fast Fourier Transform (FFT) processors 214 to 216, and are transformed into frequency domain signals. When it is assumed that an interval of a CP is longer than that of a channel impulse response, a received signal vector r^{s}(n)=[r₀^{s}(n), r₁^{s} . . . , r_{N}_{ₛ}₋₁^{s}(n)]^{T} sampled for the s-th subcarrier in which FFT has been performed is expressed in Equation (2).
r^{s}(n)=H^{s}(n)x^{s}(n)+v^{s}(n) (2)

In Equation (2), x^{s}(n)=[₀^{s}(n), . . . , x_{M}_{_{T}}₋₁^{s}(n)]^{T} denotes an M_{T}×1 transmitted signal vector, H^{s}(n)=[h₀^{s}, h₂^{s}, . . . , h_{M}_{_{T}}₋₁^{s}(n)] (hₘ^{s}=[h_{0,m}^{s}, h_{2,m}^{s}, . . . , h_{N}_{_{R}}_{-1,m}^{s}]^{T}) denotes a complex fading channel matrix, v^{s}(n) is an additive white Gaussian noise (AWGN) vector having a covariance matrix σᵥ²I_{N}_{_{R}}, and the superscript (•)^{s} denotes a subcarrier number. For simplicity, when a time index is omitted, Equation (2) can be expressed by r^{s}=H^{s}x^{s}+v^{s}.

When a turbo equalization algorithm proposed by the present invention is applied to the received signal vector, data bits are demodulated and output. A component for performing the iterative equalization algorithm is referred to as the turbo equalizer 250.

The turbo equalizer 250 includes a per-tone minimum mean square error (MMSE) equalizer 218, a component unit for decoding, and a component unit for obtaining a priori information. The component unit for decoding includes a space hopper 220, soft demappers 222 to 224, random deinterleavers 226 to 228, and MAP decoders 230 to 232. The component unit for obtaining the a priori information includes random interleavers 238 to 240, soft mappers 242 to 244, and a space hopper 246.

The per-tone MMSE equalizer 218 receives the received signal vector r^{s} and the a priori information L(xᵢ^{s}), and computes an estimate \hat{x}ᵢ^{s} (i=0,1, . . . , M_{T}−1) of a transmitted symbol xᵢ^{s}. Subsequently, the per-tone MMSE equalizer 218 computes extrinsic information L_{E}(xᵢ^{s}) using the computed estimate \hat{x}ᵢ^{s}. The computed extrinsic information L_{E}(xᵢ^{s}) is transferred to the space hopper 220, such that the original symbol arrangement is reconfigured. For example, symbols of the extrinsic information L_{E}(xᵢ^{s}) arranged according to the form of FIG. 3C are rearranged to the form of FIG. 3A. The rearranged symbol streams are transferred to soft demappers 222 to 224, and are output as coded bit streams through demapping. The coded bit streams are transferred to deinterleavers 226 to 228. The deinterleavers 226 to 228 perform a deinterleaving operation corresponding to the inverse of the interleaving operation performed by the transmitter.

Coded bit streams L(cᵢ^{s}) from the deinterleavers 226 to 228 are transferred to the MAP decoders 230 to 232. The MAP decoders 230 to 232 decode the coded bit streams L(cᵢ^{s}), and compute the extrinsic information for the coded bit streams and the decoded coded bit streams.

In FIG. 2, the extrinsic information computed for the coded bit streams L(cᵢ^{s}) is denoted by L_{D}(cᵢ^{s}), and the extrinsic information computed for the decoded coded bit streams is denoted by L_{D}(bᵢ^{s}).

The extrinsic information L_{D}(bᵢ^{s}) is used to select bits decoded in the last iteration, and the extrinsic information L_{D}(cᵢ^{s}) is transferred to the random interleavers 238 to 240, such that the a priori information L(xᵢ^{s}) can be obtained.

The extrinsic information L_{D}(cᵢ^{s}) is independently interleaved in the random interleavers 238 to 240. The interleaved coded bit streams are transferred to the mappers 242 to 244, and are mapped to symbol streams. The symbol streams are transferred to the space hopper 246. The space hopper 246 rearranges the symbol streams according to SH, and transfers the a priori information L(xᵢ^{s}) to the per-tone MMSE equalizer 218. The rearrangement based on the SH will not be described in any further detail because it has been described in relation to the transmitter.

A-2. Iterative Equalization Algorithm

For simplicity, it is assumed that Binary Phase Shift Keying (BPSK) modulated symbols, i.e., xᵢ^{s}ε{−1,+1}, are transmitted. For example, the iterative equalization algorithm may be a turbo equalization algorithm. The iterative equalization algorithm for TLSFC-OFDM is designed according to the structure 250 of FIG. 2. Turbo equalization for the s-th subcarrier is illustrated in FIG. 4.

An operator Θ 430 of FIG. 4 includes the random interleavers 238 to 240, the soft mappers 242 to 244, and the space hopper 246 of FIG. 2. An operator Θ⁻¹ 440 of FIG. 4 includes the space hopper 220, the soft demappers 222 to 224, and the random deinterleavers 226 to 228. The iterative equalization algorithm will be described with reference to FIG. 4.

Referring to FIG. 4, the per-tone MMSE equalizer 410 computes an estimate \hat{x}ᵢ^{s} (i=0,1, . . . , M_{T}−1) of a transmitted symbol xᵢ^{s} from the received vector r^{s} and the a priori information L(xᵢ^{s}) by minimizing a mean square error (MSE) E{|xᵢ^{s}−\hat{x}ᵢ^{s}|²}. The a priori information L(xᵢ^{s})=Θ(L_{D}(cₖ^{s})) is previous information associated with symbol probability of xᵢ^{s}, and is computed by the MAP decoder 420 in a previous iteration. From the a priori information L(xᵢ^{s}), the per-tone MMSE equalizer 410 can obtain a mean vector \overline{x}^{s}=[\overline{x}₀^{s}, \overline{x}₀^{s}, . . . , \overline{x}_{M}_{_{T}}₋₁^{s}] and a covariance vector \overline{v}^{s}=[\overline{v}₀^{s},\overline{v}₁^{s}, . . . , \overline{v}_{M}_{_{T}}₋₁^{s}],where

$${\overline{x}}_{i}^{s} = E [ {x}_{i}^{s} ] = {\sum }_{x ∈ B} x \cdot p ( {x}_{i}^{s} = x ) = P ( {x}_{i}^{s} = + 1 ) - P ( {x}_{i}^{s} = - 1 ) = \frac{exp ( L ( {x}_{i}^{s} ) )}{1 + exp ( L ( {x}_{i}^{s} ) )} - \frac{1}{1 + exp ( L ( {x}_{i}^{s} ) )} = tanh ( L ( {x}_{i}^{s} ) / 2 ) , and {\overline{v}}_{i}^{s} = Cov ( {x}_{i}^{s} , {x}_{i}^{s} ) = {\sum }_{x ∈ B} {\vert x - E ( {x}_{i}^{s} ) \vert}^{2} \cdot p ( {x}_{i}^{s} = x ) = 1 - {\vert {\overline{x}}_{i}^{s} \vert}^{2} .$$

In the initial equalization step, the MAP decoder 420 does not provide the a priori information. Accordingly, the a priori information L(xᵢ^{s}) is set to be zero for all i's and s's.

When the above-described points are taken into account, the per-tone MMSE equalizer 410 computes the extrinsic information L_{E}(xᵢ^{s}) using the computed estimate \hat{x}ᵢ^{s} in Equation (3).

$${L}_{E} ( {x}_{i}^{s} ) = ln \frac{P ( {x}_{i}^{s} = + 1 \vert {\hat{x}}_{i}^{s} )}{P ( {x}_{i}^{s} = - 1 \vert {\hat{x}}_{i}^{s} )} - ln \frac{P ( {x}_{i}^{s} = + 1 )}{P ( {x}_{i}^{s} = - 1 )} = ln \frac{P ( {\hat{x}}_{i}^{s} \vert {x}_{i}^{s} = + 1 )}{P ( {\hat{x}}_{i}^{s} \vert {x}_{i}^{s} = - 1 )} = \frac{4 {\hat{x}}_{i}^{s} {μ}_{{\hat{x}}_{i}^{s}}}{{σ}_{{\hat{x}}_{i}^{s}}} ,$$

where

$$\{ \begin{matrix}{\hat{x}}_{i}^{s} \sim N ( {μ}_{{\hat{x}}_{i}^{s}} , {σ}_{{\hat{x}}_{i}^{s}} ) , & {\hat{x}}_{i}^{s} = + 1 \\ {\hat{x}}_{i}^{s} \sim N ( - {μ}_{{\hat{x}}_{i}^{s}} , {σ}_{{\hat{x}}_{i}^{s}} ) , & {\hat{x}}_{i}^{s} = - 1\end{matrix} \qquad ( 3 )$$

The extrinsic information L_{E}(xᵢ^{s}) is transferred to the operator Θ⁻¹ 440, and coded bit streams L(cᵢ^{s})=Θ⁻¹(L_{E}(xᵢ^{s})) are output.

The coded bit streams L(cᵢ^{s})=Θ⁻¹(L_{E}(xᵢ^{s})) are fed to the MAP decoder 420. In M-PSK or M-QAM where M is 4, a symbol is converted into a binary, and a binary is converted into a symbol, by the soft mapper and the soft demapper between the per-tone MMSE equalizer 410 and the MAP decoder 420. In case of Quadrature Phase Shift Keying (QPSK) modulation, in-phase and quadrature components are separated after soft-input soft-output (SISO) equalization, and the extrinsic information L_{E}(xᵢ^{s}) for each component can be obtained in the same fashion as in BPSK.

The MAP decoder 420 decodes the coded bit streams L(cᵢ^{s}). Further, the MAP decoder 420 computes extrinsic information for the coded bit streams L(cᵢ^{s}) and the decoded coded bit streams.

In FIG. 4, the computed extrinsic information for the coded bit streams L(cᵢ^{s}) is denoted by L_{D}(cᵢ^{s}). L_{D}(cᵢ^{s}) can be computed from Equation (4).

$${L}_{D} ( {c}_{i}^{s} ) = ln \frac{P ( {c}_{i}^{s} = + 1 \vert L ( {c}_{i}^{0} ) , … , L ( {c}_{i}^{N - 1} ) )}{P ( {c}_{i}^{s} = - 1 \vert L ( {c}_{i}^{0} ) , … , L ( {c}_{i}^{N - 1} ) )} - ln \frac{P ( {c}_{i}^{s} = + 1 )}{P ( {c}_{i}^{s} = - 1 )} \qquad ( 4 )$$

The extrinsic information L_{D}(bᵢ^{s}) for the decoded coded bit streams from the MAP decoder 420 can be expressed as shown in Equation (5).

$${L}_{D} ( {b}_{i}^{s} ) = ln \frac{P ( {b}_{i}^{s} = + 1 \vert L ( {b}_{i}^{0} ) , … , L ( {b}_{i}^{N - 1} ) )}{P ( {b}_{i}^{s} = - 1 \vert L ( {b}_{i}^{0} ) , … , L ( {b}_{i}^{N - 1} ) )} - ln \frac{P ( {b}_{i}^{s} = + 1 )}{P ( {b}_{i}^{s} = - 1 )} \qquad ( 5 )$$

The extrinsic information L_{D}(cᵢ^{s}) is used to obtain the a priori information L(xᵢ^{s})=Θ(L_{D}(cᵢ^{s})) to be transferred to the per-tone MMSE equalizer 410. The a priori information L(xᵢ^{s}) is transferred to the per-tone MMSE equalizer 410.

A-3. Turbo Equalization Using Per-Tone MMSE Equalization

It is assumed that a transmitted symbol on the s-th tone from the i-th antenna is xᵢ^{s}. In this case, r^{s} can be defined as shown in Equation (6).
r^{s}=hᵢ^{s}xᵢ^{s}+Hᵢ^{s}xᵢ^{s}+v^{s},
where
Hᵢ^{s}=[h₀^{s},h₁^{s}, . . . , hᵢ₋₁^{s},hᵢ₊₁^{s}, . . . , h_{M}_{_{T}}₋₁^{s}]εC^{N}^{_{R}}^{×(M}^{_{T}}⁻¹⁾, and
xᵢ^{s}=[x₀^{s},x₁^{s}, . . . , xᵢ₋₁^{s},xᵢ₊₁^{s}, . . . , x_{M}_{_{T}}₋₁]^{T}εC^{(M}^{_{T}}^{-1)×1}. (6)

The per-tone MMSE equalizer cancels co-antenna interference (CAI) using the mean vector \overline{x}ᵢ^{s}. The output of interference cancellation from the per-tone MMSE equalizer is obtained as shown in Equation (7).
yᵢ^{s}=r^{s}−Hᵢ^{s}\overline{x}ᵢ^{s}=hᵢ^{s}xᵢ^{s}+Hᵢ^{s}(xᵢ^{s}−\overline{x}ᵢ^{s})+v^{s} (7)

For simplicity, the superscript (•)^{s} is omitted hereinafter.

By applying an orthogonal principle, a tap weight vector wᵢ (based on an exact MMSE solution) can be obtained from Equation (8).
wᵢ=E[yᵢyᵢ^{H}]⁻¹E[yᵢxᵢ*]=(HPᵢH^{H}+σᵥ²I)⁻¹h (8)

In Equation (8), the superscripts (•)^{H} and (•)* denote the transpose conjugate and the conjugate, respectively.

Pᵢ shown in Equation (8) can be defined as shown in Equation (9).

$${P}_{i} = Diag \{ {p}_{0} , {p}_{1} , … , {p}_{{M}_{T} - 1} \} , {p}_{j} = \{ \begin{matrix}1 , & i = j \\ 1 - {\vert {\hat{x}}_{j} \vert}^{2} , & i \neq j\end{matrix} \qquad ( 9 )$$

The equalizer output \hat{x}ᵢ and the statistics μ_{\hat{x}}_{ᵢ} and ν_{\hat{x}}_{ᵢ}² are computed from Equation (10).
\hat{x}ᵢ=wᵢ^{H}yᵢ=hᵢ^{H}((HPᵢH^{H}+σᵥ²I)⁻¹)^{H}yᵢ
μ_{\hat{x}}_{ᵢ}=wᵢ^{H}hᵢ=hᵢ^{H}((HPᵢH^{H}+σᵥ²I)⁻¹)^{H}hᵢ
σ_{\hat{x}}_{ᵢ}²=wᵢ^{H}{HᵢQᵢHᵢ^{H}+σᵢ²I}wᵢ,
where
Qᵢ=Diag{q₀,q₁, . . . , qᵢ₋₁, qᵢ₊₁, . . . , q_{M}_{_{T}}₋₁},qⱼ=1−|\hat{x}ⱼ|². (10)

Computing wᵢ for each iteration requires high implementation complexity because of the matrix inversion. This complexity can be reduced by using time-invariant coefficients. One way to yield the time-invariant coefficients is to assume that the a priori information is perfect, i.e., |L(xᵢ)|→∞. In this case, the tap weight vector wᵢ can be expressed as shown in Equation (11).

$${w}_{i} = {( {h}_{i} {h}_{i}^{H} + {σ}_{v}^{2} I )}^{- 1} {h}_{i} = \frac{{h}_{i}}{{\sum }_{j = 0}^{{N}_{R} - 1} {\vert {h}_{ij} \vert}^{2} + {σ}_{v}^{2}} \qquad ( 11 )$$

When Equation (11) is inserted into Equation (10), the equalizer output \hat{x}ᵢ and the statistics μ_{\hat{x}}_{ᵢ} and σ_{\hat{x}}_{ᵢ}² can be rewritten as shown in Equation (12).

$${\hat{x}}_{i} = {w}_{i}^{H} {y}_{i} = \frac{{h}_{i}^{H} {y}_{i}}{{\sum }_{j = 0}^{{N}_{R} - 1} {\vert {h}_{ij} \vert}^{2} + {σ}_{v}^{2}} \\ {μ}_{{\hat{x}}_{i}} = {w}_{i}^{H} {h}_{i} = \frac{{\sum }_{j = 0}^{{N}_{R} - 1} {\vert {h}_{ij} \vert}^{2}}{{\sum }_{j = 0}^{{N}_{R} - 1} {\vert {h}_{ij} \vert}^{2} + {σ}_{v}^{2}} \\ {σ}_{{\hat{x}}_{i}}^{2} = {w}_{i}^{H} \{ {H}_{i} {Q}_{i} {H}_{i}^{H} + {σ}_{i}^{2} I \} {w}_{i} . \qquad ( 12 )$$

B. Unordered SIC-Based TLSFC-OFDM

The iteration procedure based on the above-described iterative equalization algorithm requires a predetermined number of iterations for system convergence. Accordingly, when the number of iterations required for system convergence is reduced, system performance can be improved.

As a new method for reducing the number of iterations needed for system convergence, an SIC algorithm for the TLSFC-OFDM system is proposed. The SIC algorithm requires an ordering scheme that determines the detection order of layers in order to maximize the minimum post-detection SNR. For example, the conventional OFDM/Horizontal Bell Labs Layered Space-Time (H-BLAST) scheme uses a capacity mapping ordering scheme (CMOS). In a frequency selective fading channel, layers of each tone have a different order of SNRs, such that the detection order varies from tone to tone. In addition, if each layer is a code word as in H-BLAST, all symbols in a layer are detected and CAI must be removed from the detected symbols. Because the OFDM/H-BLAST scheme cannot directly implement the conventional SIC algorithm, it uses the CMOS to calculate the equivalent SNR of each layer. A process for calculating the equivalent SNR has high computational complexity because it requires matrix inverse transformation.

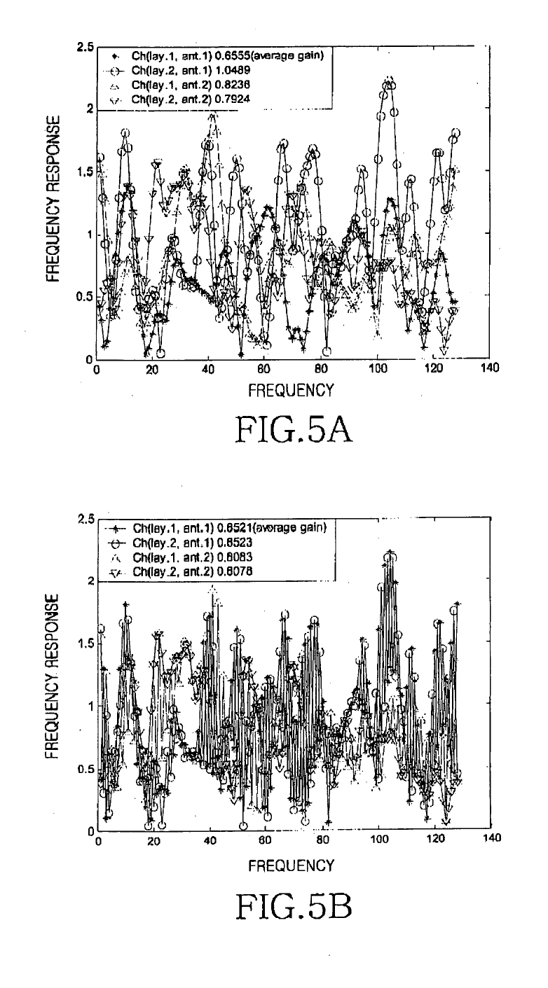

The TLSFC-OFDM system proposed by the present invention use the SH scheme. Accordingly, the TLSFC-OFDM system makes the equivalent SNRs of all layers similar, thereby performing the layer detections and the CAI cancellations in an arbitrary order without the ordering process. The equivalent SNRs of all layers are similar because average values of channel frequency responses between all layers and receive antennas are almost the same in case of using SH. This scenario is illustrated in FIGS. 5A and 5B.

FIG. 5A is a graph illustrating simulation results when the SH scheme proposed by the present invention is not applied, and FIG. 5B is a graph illustrating simulation results when the SH scheme proposed by the present invention is applied. In FIGS. 5A and 5B, Ch (lay.m, ant.n) denotes the frequency response between layer m (at the transmitter) and receiver antenna n. When the average value of Ch (lay. 1, ant. 1) is compared with that of Ch (lay. 2, ant. 1), when SH is not used, there is a significant difference therebetween. That is, the OFDM symbols transmitted over Ch (lay. 1, ant. 1) suffer from more deteriorated channel than those transmitted over Ch (lay. 2, ant. 1). However, the average values of Ch (lay. 1, ant. 1) and Ch (lay. 2, ant. 1) are almost the same when using SH.

When all subcarriers in an OFDM system suffer from the poor channel, the improvement of BER performance through channel coding is limited. The errors from the OFDM symbol are the dominant factor in overall BER performance. The SH increases the effect of channel coding by reducing the probability that all subcarriers experience poor channels.

As described above, the TLSFC-OFDM receiver proposed by the present invention iteratively performs two steps of MMSE equalization and MAP decoding. In the TLSFC-OFDM receiver without using the SIC algorithm, extrinsic information for all layers is computed simultaneously at each step, and is fed to the next step. In contrast, the two steps of MMSE equalization and MAP decoding in the unordered SIC-based TLSFC-OFDM receiver are successively performed for a layer of the current detection order, and the resultant output is exploited as a priori information for detecting a layer of the next order.

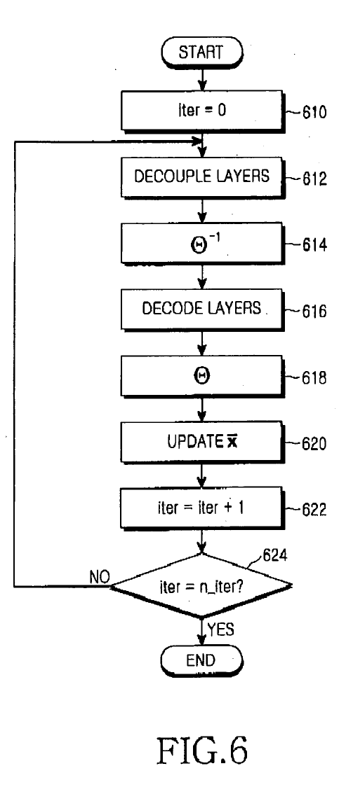

FIG. 6 is a flow chart illustrating a turbo equalization procedure in the TLSFC-OFDM system, without using a successive interference cancellation (SIC) algorithm proposed by the present invention. In step 610, a parameter value of “iter” is set to 0. The parameter value of “iter” indicates the current number of iterations. In step 612, turbo equalization using per-tone MMSE equalization for each layer is performed. In step 614, a process corresponding to an operator Θ⁻¹ is performed on extrinsic information L_{E}(xᵢ^{s}) output by the turbo equalization. The operator Θ⁻¹ represents that all layers are space-hopped, demapped, and deinterleaved. In step 616, a coded bit stream L(cᵢ^{s}) output by the operator Θ⁻¹ is decoded. According to the decoding operation, extrinsic information L_{D}(cᵢ^{s}) computed for the coded bits and extrinsic information L_{D}(bᵢ^{s}) computed for the decoded bit streams are output.

In step 618, a process corresponding to an operator Θ is performed on L_{D}(cᵢ^{s}). The operator Θ represents that all layers are interleaved, mapped, and space-hopped. In step 620, a mean vector \overline{x}^{s} is computed from a priori information L(xᵢ^{s}) output by the operator Θ, and a previous mean vector is updated to the computed mean vector \overline{x}^{s}. In step 622, the parameter value of “iter” is incremented by one. In step 624, a determination is made as to whether the parameter value of “iter” reaches a preset value of “n_iter”. If the parameter value of “iter” does not reach the preset value of “n_iter”, the procedure returns to step 612, such that the above operation is iteratively performed. The preset value of “n_iter” indicates the total number of iterations in which the iterative equalization algorithm is performed.

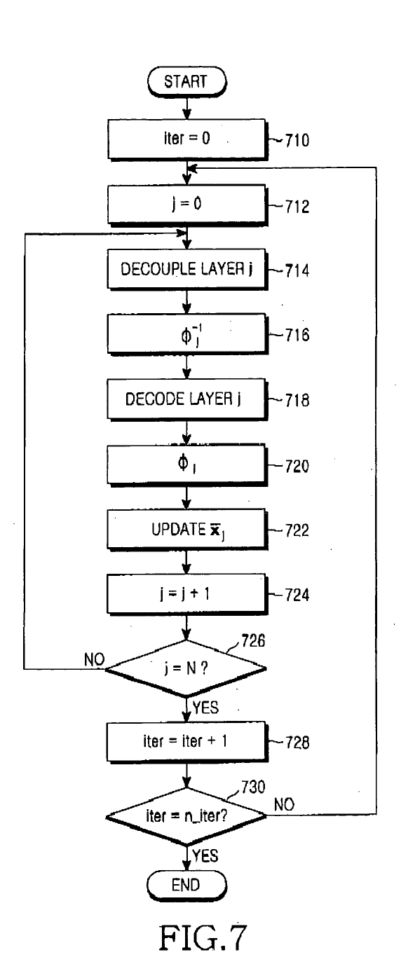

The turbo equalization procedure in the TLSFC-OFDM system using the SIC algorithm will be described with reference to FIG. 7. Referring to FIG. 7, in step 710, a parameter value of “iter” is set to 0. In step 712, a parameter value of “j” for counting a layer is set to 0. In step 714, turbo equalization using per-tone MMSE equalization for the j-th layer is performed. In step 716, a process corresponding to an operator φⱼ⁻¹ is performed on extrinsic information L_{E}(xᵢ^{s}) output by the turbo equalization. The operator φⱼ⁻¹ represents that the j-th layer is space-hopped, demapped, and deinterleaved. In step 718, a coded bit stream L(cᵢ^{s}), associated with the j-th layer, output by the operator φⱼ⁻¹ is decoded. According to the decoding operation, extrinsic information L_{D}(cᵢ^{s}) computed for the coded bits and extrinsic information L_{D}(bᵢ^{s}) computed for the decoded bit streams are output.

In step 720, a process corresponding to an operator φⱼ is performed on L_{D}(cᵢ^{s}). The operator φⱼ represents that the j-th layer is interleaved, mapped, and space-hopped. In step 722, a mean vector \overline{x}ⱼ is computed from a priori information L(xᵢ^{s}), associated with the j-th layer, output by the operator φⱼ, and a previous mean vector is updated by the computed mean vector \overline{x}ⱼ. In step 724, the parameter value of “j” is incremented by one.

In step 726, it is determined if the parameter value of “j” reaches the total number of layers N. That is, a determination is made as to whether the per-tone MMSE equalization step and the MAP decoding step have been performed for all the layers. If the parameter value of “j” does not reach the total number of layers N, the procedure returns to step 714 to continuously perform the per-tone MMSE equalization step and the MAP decoding step for the j-th layer.

However, if the per-tone MMSE equalization step and the MAP decoding step have been performed for all the layers (step 728), a determination is made as to whether the parameter value of “iter” reaches a preset value of “n_iter” in step 730. If the parameter value of “iter” does not reach the preset value of “n_iter”, the procedure returns to step 712, such that the above operation is iteratively performed.

As described in relation to FIGS. 6 and 7, the TLSFC-OFDM receiver iteratively performs the per-tone MMSE equalization step and the MAP decoding step. As illustrated in FIG. 6, the TLSFC-OFDM system without using the SIC algorithm decouples and decodes all the layers in each step. Extrinsic information of all the layers computed in each step is simultaneously fed to the next step. However, the unordered SIC-based TLSFC-OFDM system, as illustrated in FIG. 7, successively performs two steps of MMSE equalization and MAP decoding for a layer based on a current detection order, and the resultant output is used as the a priori information for detecting another layer of the next order.

The TLSFC-OFDM system without SIC and the unordered SIC-based TLSFC-OFDM system require the same computational complexity in one iteration process. For example, they perform the same computation process, except that the TLSFC-OFDM system without SIC performs a process in a parallel fashion and the unordered SIC-based TLSFC-OFDM system performs a process in a serial fashion. As such, the same amount of signal processing is required for both the systems. However, because each layer exploits more exact information than the previously processed layer, the performance improvement produced by each iteration is larger in the unordered SIC-based TLSFC-OFDM system than in the TLSFC-OFDM system without SIC. As a result, the unordered SIC-based TLSFC-OFDM system can reduce computation power by decreasing the number of iterations without additional hardware complexity.

C. Simulation Results

In the simulation, an OFDM system with 64 subcarriers and CP length set to the channel maximum delay is taken into account. In this case, a Rayleigh fading channel with four paths and the normalized Doppler frequency f_{D}NTₛ=10⁻⁴, where f_{D} is the maximum Doppler frequency, and Tₛ is a sample period of an OFDM signal. Data is encoded by a rate 1/2 convolutional code with a generator polynomial G=(7,5)₈, and is modulated by QPSK. Results of the BER performances of the TLSFC-OFDM system with perfect channel and interference information are compared.

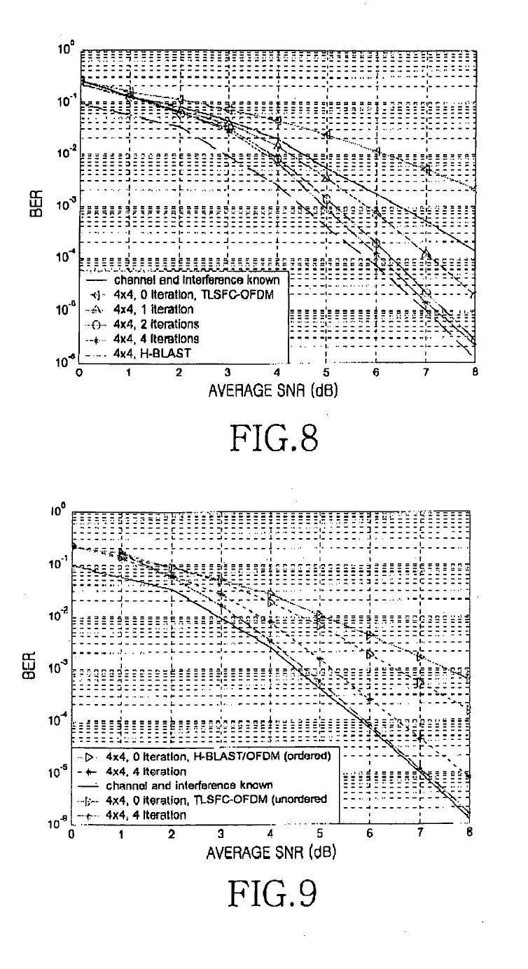

FIG. 8 is a graph illustrating a BER performance comparison between the TLSFC-OFDM system with the exact MMSE solution proposed by the present invention and the conventional OFDM/H-BLAST system. As illustrated in FIG. 8, the TLSFC-OFDM system proposed by the present invention offers improved performance over the conventional OFDM/H-BLAST system by about 2 dB at a BER of 10⁻⁴. For three or four iterations, it can be seen that the performance of the TLSFC-OFDM system with perfect channel information approaches the performance of a system with perfect channel and interference information.

FIG. 9 is a graph illustrating a BER performance comparison between the conventional H-BLAST/OFDM system using the turbo principle and the TLSFC-OFDM system using SIC proposed by the present invention. As illustrated in FIG. 9, a performance gain obtained by using SH is about 0.8 dB at a BER of 10⁻⁵. It should be noted that the TLSFC-OFDM system does not require an ordering process such as the CMOS required by the conventional H-BLAST/OFDM system. Accordingly, the TLSFC-OFDM system can reduce a large amount of computation as compared with the conventional H-BLAST/OFDM system.

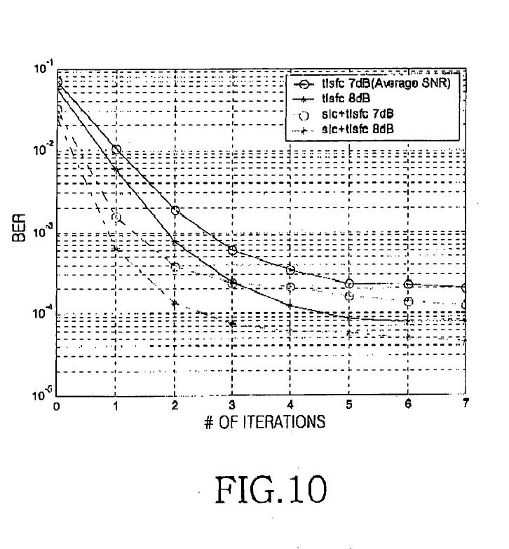

FIG. 10 is a graph illustrating the BER performances according to the number of iterations in the TLSFC-OFDM system with the simplified MMSE solution proposed by the present invention and the SIC-based TLSFC-OFDM system. As illustrated in FIG. 10, the TLSFC-OFDM system using SIC not only provides improved performance, but also reduces the number of iterations by about two.

As is apparent from the above description, the present invention can obtain both a multiplexing gain and a transmit diversity gain by adding space hopping to a transmitter of a turbo layered space-frequency coded orthogonal frequency division multiplexing (TLSFC-OFDM) system. By applying a turbo principle in a receiver, the present invention outperforms the conventional OFDM/Horizontal Bell Labs Layered Space-Time (H-BLAST) system.

The present invention requires the same amount of signal processing as that of a system without using successive interference cancellation (SIC). However, the performance improvement produced by each iteration is large because the next layer exploits more exact information than the previously processed layer. As a result, an unordered SIC-based TLSFC-OFDM system can reduce computation power by decreasing the number of iterations without additional hardware complexity.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for transmitting symbol streams in a transmitter of a mobile communication system supporting an orthogonal frequency division multiplexing (OFDM) scheme, wherein the transmitter includes a plurality of transmit antennas, separates one data stream into a plurality of substreams, encodes the plurality of substreams, and outputs the symbol streams, comprising:
space hopping the symbol streams;
rearranging symbols included in the symbol streams;
transforming the rearranged symbol streams using Inverse Fast Fourier Transform (IFFT);
inserting cyclic prefixes (CPs) into the transformed rearranged symbol streams; and
transmitting, through the plurality of transmit antennas, the transformed rearranged symbol streams into which the CPs have been inserted.

2. The method according to claim 1, wherein a number of substreams is equal to a number of transmit antennas.

3. The method according to claim 1, wherein symbols using a same frequency band in the symbol streams are rearranged by space hopping.

4. The method according to claim 3, wherein the frequency band is distinguished subcarrier by subcarrier.

5. The method according to claim 1, wherein when an s-th symbol of an i-th symbol stream among the symbol streams is aᵢ^{s}, the symbol aᵢ^{s} is rearranged in a position of an s-th symbol of a k-th symbol stream among the symbol streams, k being computed from k=(i+s) mod M_{T} where M_{T} denotes a number of the transmit antennas.

6. A transmitter of a mobile communication system supporting an orthogonal frequency division multiplexing (OFDM) scheme, wherein the transmitter separates one data stream into a plurality of substreams, encodes the plurality of substreams, and outputs the symbol streams, comprising:
a space hopper for performing space hopping between the symbol streams, and rearranging symbols included in the symbol streams;
Inverse Fast Fourier Transform (IFFT) processors for transforming the rearranged symbol streams using IFFT;
cyclic prefix (CP) inserters for inserting CPs into the symbol streams modulated by the IFFT, and
transmit antennas for transmitting the modulated symbol streams into which the CPs have been inserted.

7. The transmitter according to claim 6, wherein a number of substreams is equal to a number of transmit antennas.

8. The transmitter according to claim 6, wherein the space hopper rearranges symbols using a same frequency band in the symbol streams.

9. The transmitter according to claim 8, wherein the frequency band is distinguished subcarrier by subcarrier.

10. The transmitter according to claim 6, wherein when an s-th symbol of an i-th symbol stream among the symbol streams is aᵢ^{s}, the space hopper rearranges the symbol aᵢ^{s} in a position of an s-th symbol of a k-th symbol stream among the symbol streams, k being computed from k=(i+s) mod M_{T}, where M_{T} denotes a number of the transmit antennas.

11. A method for decoding coded bits from symbol streams in a receiver of a mobile communication system supporting an orthogonal frequency division multiplexing (OFDM) scheme, wherein the receiver includes a plurality of receive antennas, removes cyclic prefixes (CPs) from modulated symbol streams received by the plurality of receive antennas, and outputs the symbol streams through Fast Fourier Transform (FFT), the method comprising:
performing an initial equalization process for computing an estimate \hat{x}ᵢ^{s} of a transmitted symbol from symbols r^{s}(n)=[r₀^{s}(n), r₁^{s} . . . , r_{N}_{ₛ}₋₁^{s}(n)]^{T} configuring the symbol streams, and obtaining extrinsic information L_{E}(xᵢ^{s}) by inserting the estimate \hat{x}ᵢ^{s}, into:
$${L}_{E} ( {x}_{i}^{s} ) = ln \frac{P ( {x}_{i}^{s} = + 1 \vert {\hat{x}}_{i}^{s} )}{P ( {x}_{i}^{s} = - 1 \vert {\hat{x}}_{i}^{s} )} - ln \frac{P ( {x}_{i}^{s} = + 1 )}{P ( {x}_{i}^{s} = - 1 )} = ln \frac{P ( {\hat{x}}_{i}^{s} \vert {x}_{i}^{s} = + 1 )}{P ( {\hat{x}}_{i}^{s} \vert {x}_{i}^{s} = - 1 )} = \frac{4 {\hat{x}}_{i}^{s} {μ}_{{\hat{x}}_{i}^{s}}}{{σ}_{{\hat{x}}_{i}^{s}}} , \\ where \{ \begin{matrix}{\hat{x}}_{i}^{s} \sim N ( {μ}_{{\hat{x}}_{i}^{s}} , {σ}_{{\hat{x}}_{i}^{s}} ) , & {\hat{x}}_{i}^{s} = + 1 \\ {\hat{x}}_{i}^{s} \sim N ( - {μ}_{{\hat{x}}_{i}^{s}} , {σ}_{{\hat{x}}_{i}^{s}} ) , & {\hat{x}}_{i}^{s} = - 1\end{matrix} ;$$
performing an equalization process for receiving symbols r^{s}(n)=[r₀^{s}(n),r₁^{s} . . . , r_{N}_{ₛ}₋₁^{s}(n)]^{T} included in the symbol streams and a priori information L(xᵢ^{s}), and obtaining extrinsic information L_{E}(xᵢ^{s});
processing the extrinsic information L_{E}(xᵢ^{s}), obtained through the initial equalization process and the equalization process, using a predetermined operator, and outputting a coded bit stream L(cᵢ^{s});
receiving and decoding the coded bit stream L(cᵢ^{s});
outputting extrinsic information L_{D}(cᵢ^{s}) for the coded bit stream L(cᵢ^{s}) using
$${L}_{D} ( {c}_{i}^{s} ) = ln \frac{P ( {c}_{i}^{s} = + 1 \vert L ( {c}_{i}^{0} ) , … , L ( {c}_{i}^{N - 1} ) )}{P ( {c}_{i}^{s} = - 1 \vert L ( {c}_{i}^{0} ) , … , L ( {c}_{i}^{N - 1} ) )} - ln \frac{P ( {c}_{i}^{s} = + 1 )}{P ( {c}_{i}^{s} = - 1 )} ;$$
outputting extrinsic information L_{D}(bᵢ^{s}) for the decoded bit stream using
$${L}_{D} ( {b}_{i}^{s} ) = ln \frac{P ( {b}_{i}^{s} = + 1 \vert L ( {b}_{i}^{0} ) , … , L ( {b}_{i}^{N - 1} ) )}{P ( {b}_{i}^{s} = - 1 \vert L ( {b}_{i}^{0} ) , … , L ( {b}_{i}^{N - 1} ) )} - ln \frac{P ( {b}_{i}^{s} = + 1 )}{P ( {b}_{i}^{s} = - 1 )} ;$$
processing the extrinsic information L_{D}(cᵢ^{s}) for the coded bit stream using a predetermined operator; and
outputting the a priori information L(xᵢ^{s}).

12. The method according to claim 11, wherein processing of the predetermined operator for outputting the coded bit stream L(cᵢ^{s}) comprises:
performing space hopping on the extrinsic information L_{E}(xᵢ^{s}); and
demapping and deinterleaving the information on which the space hopping has been performed.

13. The method according to claim 11, wherein processing of the predetermined operator for outputting the a priori information L(xᵢ^{s}) comprises:
interleaving the extrinsic information L_{D}(cᵢ^{s}) for the coded bit stream; and
mapping and space hopping the interleaved information.

14. An apparatus for decoding coded bits from symbol streams in a receiver of a mobile communication system supporting an orthogonal frequency division multiplexing (OFDM) scheme, wherein the receiver includes a plurality of receive antennas, removes cyclic prefixes (CPs) from modulated symbol streams received by the plurality of receive antennas, and outputs the symbol streams through Fast Fourier Transform (FFT), the apparatus comprising:
an equalizer for performing an initial equalization process for computing an estimate \hat{x}ᵢ^{s} of a transmitted symbol from symbols r^{s}(n)=[r₀(n), r₁^{s} . . . , r_{N}_{ₛ}₋₁^{s}(n)]^{T} configuring the symbol streams, and obtaining extrinsic information L_{E}(xᵢ^{s}) by inserting the estimate \hat{x}ᵢ^{s} into:
$${L}_{E} ( {x}_{i}^{s} ) = ln \frac{P ( {x}_{i}^{s} = + 1 \vert {\hat{x}}_{i}^{s} )}{P ( {x}_{i}^{s} = - 1 \vert {\hat{x}}_{i}^{s} )} - ln \frac{P ( {x}_{i}^{s} = + 1 )}{P ( {x}_{i}^{s} = - 1 )} = ln \frac{P ( {\hat{x}}_{i}^{s} \vert {x}_{i}^{s} = + 1 )}{P ( {\hat{x}}_{i}^{s} \vert {x}_{i}^{s} = - 1 )} = \frac{4 {\hat{x}}_{i}^{s} {μ}_{{\hat{x}}_{i}^{s}}}{{σ}_{{\hat{x}}_{i}^{s}}} , \\ where \{ \begin{matrix}{\hat{x}}_{i}^{s} \sim N ( {μ}_{{\hat{x}}_{i}^{s}} , {σ}_{{\hat{x}}_{i}^{s}} ) , & {\hat{x}}_{i}^{s} = + 1 \\ {\hat{x}}_{i}^{s} \sim N ( - {μ}_{{\hat{x}}_{i}^{s}} , {σ}_{{\hat{x}}_{i}^{s}} ) , & {\hat{x}}_{i}^{s} = - 1\end{matrix} ,$$
and performing an equalization process for receiving symbols r^{s}(n)=[r₀^{s}(n),r₁^{s} . . . , r_{N}_{ₛ}₋₁^{s}(n)]^{T} included in the symbol streams and a priori information L(xᵢ^{s}), and obtaining extrinsic information L_{E}(xᵢ^{s});
a first operator for processing the extrinsic information L_{E}(xᵢ^{s}), obtained through the initial equalization process and the equalization process, using a predetermined operator, and outputting a coded bit stream L(cᵢ^{s});
a decoder for receiving and decoding the coded bit stream L(cᵢ^{s}), outputting extrinsic information L_{D}(cᵢ^{s}) for the coded bit stream L(cᵢ^{s}) using
$${L}_{D} ( {c}_{i}^{s} ) = ln \frac{P ( {c}_{i}^{s} = + 1 \vert L ( {c}_{i}^{0} ) , … , L ( {c}_{i}^{N - 1} ) )}{P ( {c}_{i}^{s} = - 1 \vert L ( {c}_{i}^{0} ) , … , L ( {c}_{i}^{N - 1} ) )} - ln \frac{P ( {c}_{i}^{s} = + 1 )}{P ( {c}_{i}^{s} = - 1 )} ,$$
and outputting extrinsic information L_{D}(bᵢ^{s}) for the decoded bit stream using
$${L}_{D} ( {b}_{i}^{s} ) = ln \frac{P ( {b}_{i}^{s} = + 1 \vert L ( {b}_{i}^{0} ) , … , L ( {b}_{i}^{N - 1} ) )}{P ( {b}_{i}^{s} = - 1 \vert L ( {b}_{i}^{0} ) , … , L ( {b}_{i}^{N - 1} ) )} - ln \frac{P ( {b}_{i}^{s} = + 1 )}{P ( {b}_{i}^{s} = - 1 )} ; and$$
a second operator for processing the extrinsic information L_{D}(cᵢ^{s}) for the coded bit stream using a predetermined operator, and outputting the a priori information L(xᵢ^{s}).

15. The apparatus according to claim 14, wherein the first operator comprises:
a space hopper for performing space hopping on the extrinsic information L_{E}(xᵢ^{s});
a plurality of demappers, each demapping the information on which the space hopping has been performed; and
a plurality of deinterleavers, each deinterleaving the demapped information and outputting the coded bit stream L(cᵢ^{s}).

16. The apparatus according to claim 14, wherein the second operator comprises:
a plurality of interleavers, each interleaving the extrinsic information L_{D}(cᵢ^{s}) for the coded bit stream;
a plurality of mappers, each mapping the interleaved information; and
a space hopper for space hopping the mapped information, and outputting the a priori information L(xᵢ^{s}).
